(19) United States
(12) Patent Application Publication
(10) Pub. No.: US 2020/0189480 A1
(43) Pub. Date: Jun. 18, 2020

(54) Cargo Carrier System for Vehicles with Stretchable Cover

(71) Applicant: Dennis Jay Potter, Midway, UT (US)

(72) Inventor: Dennis Jay Potter, Midway, UT (US)

(21) Appl. No.: 16/727,269

(22) Filed: Dec. 26, 2019

Related U.S. Application Data
(63) Continuation-in-part of application No. 16/217,535, filed on Dec. 12, 2018.

(51) Int. Cl. B60R 9/06

(52) U.S. Cl. CPC B60R 9/065

(57) ABSTRACT

A cargo carrier for a vehicle top includes a base portion and a cover. The base portion defines a cargo compartment. A sidewall surrounds the entirety of the cargo compartment and includes a male cantilevered portion. A cover for the base portion is formed of an elastic material that allows the cover to stretch to accommodate cargo of different sizes in the cargo compartment. An edge of the cover may include a J-hook with a channel for receiving the male cantilevered portion to thereby attach the cover to the base portion.

### BACKGROUND

### 1. The Field of the Present Disclosure

The present disclosure relates generally to cover systems for cargo areas of vehicles, and more particularly, but not necessarily entirely, to tonneau cover systems, hitch mounted tailgate cargo systems, and cargo top carriers for vehicles.

### 2. Description of Related Art

Vehicle, trailer and vehicle top cargo carrier manufacturers supply various models of trailers, vehicles, and cargo carriers that have open beds on which to place cargo for transit. Such truck beds, trailer beds, and cargo carriers typically have limited or no method of protecting cargo from the weather, water or debris. Furthermore, such truck beds, trailer beds, and cargo carriers typically have a limited or no method of securing cargo from movement.

Under one solution to secure and protect cargo in a truck bed or cargo top carrier, the cargo was simply covered with a tarpaulin or tarp. Cords, straps, or bungees were then used to secure the tarp over the cargo and to the sidewalls of the truck bed. However, tarp users objected to the bulky and awkward to handle nature of tarps. For example, tarps often come loose at high speeds and flap away from the cargo they are supposed to protect. Additionally, securing the tarp with cords, straps, or bungees proved difficult and time consuming.

Under another solution to protect cargo in a truck bed, several types of bed enclosures, known as tonneau covers, were designed to cover the truck bed in such a way that small cargo could be protected from the weather. In the past, tonneau covers have been provided with soft and hard covers, as explained below.

Soft Tonneau Covers: A soft tonneau cover is usually made from non-stretchable vinyl or another fabric material that is installed over a truck bed. These covers are versatile, durable, and are available with a lot of different options. They usually come as either snap-on or snap-less covers. Some soft tonneau covers roll up for easy storage near the cab, while others can be removed to provide access to the truck bed.

Hard Tonneau Covers: A hard tonneau cover is a rigid cover that acts much like a hood or trunk over the truck bed. Hard tonneau covers are made of fiberglass, metal, or plastic and come with a wide range of options. Some are folding models with solid panels that fold and stack on themselves, while others are solid, one-piece hinged designs that give a sleek appearance with no seams.

One drawback to previously available soft and hard tonneau covers is that they do not easily expand or stretch to cover cargo higher than the sidewalls of the truck bed or cargo top carrier. That is, previously available tonneau covers limited the height of the cargo that could be placed into the truck bed. Typically, if the cargo was taller than the sidewalls of the truck bed, the tonneau cover had to be removed. Further, tonneau cover manufacturers specifically state that cargo should not come into contact with the covers.

An attempted solution to this “height” problem is disclosed by applicant in his U.S. Pat. Nos. 9,061,572 and 8,973,969. Applicant's solution involved using a foldable tonneau cover with integral straps. This foldable tonneau cover remained folded during normal usage. To secure tall cargo in the truck bed, the foldable tonneau cover unfolded to accommodate cargo taller than the sidewalls of the truck bed. Applicant's foldable tonneau cover, however, proved expensive to manufacture and difficult to use by untrained users.

Another attempted solution to this “height” problem is disclosed in U.S. D689,426 issued to Jaramillo. Jaramillo's solution involves a tarpaulin cover with an integral, web-like elastic cord system. The disadvantages to this tarpaulin cover, however, are many. First, this tarpaulin cover is not fully weather proof as gaps will exist between the sidewalls of the truck bed and the cover. That is, Jaramillo's tarpaulin cover does not fully protect or secure cargo within the pickup bed truck. Second, this tarpaulin cover is complicated and expensive to manufacture with either a very large die or many parts. Lastly, this tarpaulin material is made from an easily tearable non-composite material and the tarpaulin material itself does not appear to stretch.

Thus, there still exists a need in the art for a tonneau cover that easily expands or stretches to accommodate cargo taller than the sidewalls of the truck bed and that is fully weather proof.

The prior art is thus characterized by several disadvantages that are addressed by the present disclosure. The present disclosure minimizes, and in some respects eliminates, the above-mentioned failures, and other problems, by utilizing the methods and structural features described herein.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 shows an isometric view of a vehicle utilizing a tonneau cover system installed over the vehicle's cargo bed according to an embodiment of the present disclosure;

FIG. 2 shows an isometric view of the vehicle depicted in FIG. 1, where the cover of the tonneau system is expanded and stretched to fit over and restrain cargo within the vehicle's cargo bed;

FIG. 3 shows an exploded view of the tonneau cover system of FIG. 1;

FIG. 4 shows an exploded isometric view of some of the components of the tonneau cover system of FIG. 1;

FIG. 5 shows an exploded and fragmentary view of some of the components of a corner assembly of the tonneau cover system shown in FIG. 1;

FIG. 6 shows an exploded and fragmentary view of some the components of a corner assembly of the tonneau cover system;

FIG. 7 shows a fragmentary view of some of the components of a corner assembly of the tonneau cover system of FIG. 1;

FIG. 8 shows a fragmentary and cross-sectional view of the tonneau cover system of FIG. 1 with the cover in an unstretched position;

FIG. 9 shows a fragmentary and cross-sectional view of the tonneau cover system of FIG. 2 with the cover in a stretched position over cargo in the vehicle cargo bed;

FIG. 10 shows a tonneau cover installed on a vehicle and depicts the stretch height and width of the tonneau cover;

FIG. 11 shows a cargo carrier with a stretchable cover mounted to a roof rack of a vehicle;

FIG. 12 shows the cargo carrier of FIG. 11 loaded with cargo and the stretchable cover stretched over the cargo;

FIG. 13 depicts a side view of an embodiment of an unloaded cargo carrier mounted to a top of a vehicle;

FIG. 14 depicts a side view of the cargo carrier shown in FIG. 13, but with a load;

FIG. 15 depicts a front view of the cargo carrier shown in FIG. 13;

FIG. 16 depicts the cargo carrier in FIG. 15, but with a load.

FIG. 17 depicts an exploded view of the cargo carrier shown in FIG. 13 without the cover;

FIG. 18 depicts a front view of the cargo carrier shown in FIG. 13 without the cover;

FIG. 19 depicts a cross-sectional view of the cargo carrier along the section B-B shown in FIG. 18;

FIG. 20 depicts a side view of the cargo carrier shown in FIG. 13 without the cover;

FIG. 21 depicts a cross-sectional view of the cargo carrier shown in FIG. 13 along the section A-A shown in FIG. 20; and

FIG. 22 depicts a cross-sectional view of the cargo carrier shown in FIG. 13 along the section C-C shown in FIG. 14 and with the cover and a load.

### DETAILED DESCRIPTION

For the purposes of promoting and understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “containing,” “characterized by,” and grammatical equivalents thereof are inclusive or open-ended terms that do not exclude additional, unrecited elements or method steps.

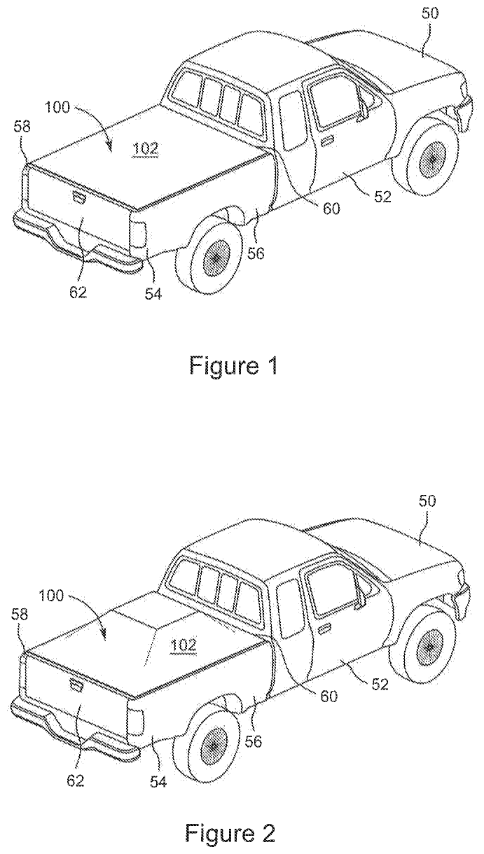

For description purposes herein, the terms “over”, “under”, “top”, “bottom”, “front”, “rear”, “left”, “right” relate generally to the vehicle as oriented in FIGS. 1 and 2. That is, “front” is generally in the direction of travel of a vehicle while “rear” is in the opposite direction. “Left” refers to the driver side of a vehicle while “right” refers to the passenger side of a vehicle. It is understood that embodiments of the present invention may assume other various alternative orientations and sequences except where expressly specified to the contrary. Additionally, it is to be understood that the specific details and processes illustrated in the drawings and described in the specifications are simple exemplary embodiments. Hence, specific dimensions, other physical characteristics and materials relating to the embodiments disclosed herein are not to be considered as limiting, unless the claims expressly state otherwise.

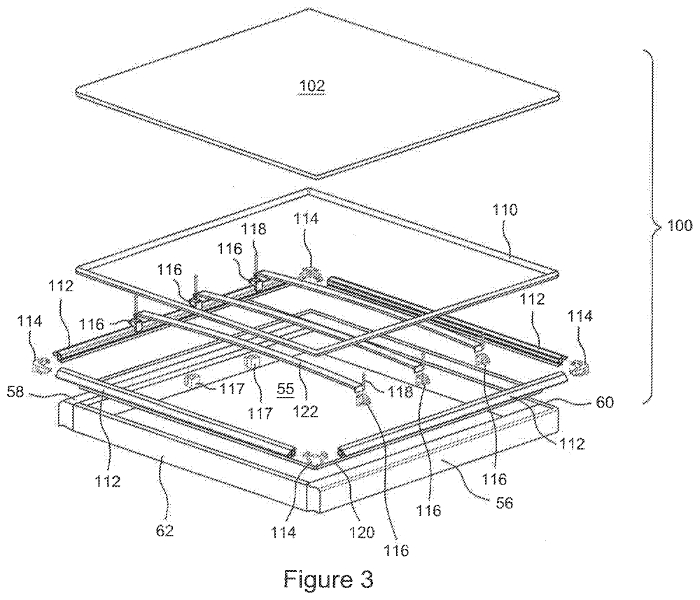

Referring now to FIG. 1, a tonneau cover system 100 is shown mounted on a vehicle 50 according to an embodiment of the present disclosure. The vehicle 50 includes a front cab 52 and a truck bed 54. The truck bed 54 may include sidewalls that form a cargo compartment 55 (shown in FIGS. 3, 4, 8 and 9), including opposing sidewalls 56 and 58, a front wall 60 and a rear wall 62 as is known to those having ordinary skill in the art. It will be appreciated that the rear wall 62 may include a tail gate, as is common in most pick-up trucks. It will be further appreciated that while the present disclosure is suited for pick-up trucks, it may be used on trailers, hitch mounted tailgate cargo systems, flatbeds, flatbed trucks, other types of vehicles with uncovered cargo compartments, and vehicle top cargo carriers.

The system 100 includes a tonneau cover 102 that extends over the cargo compartment 55. For example, the cover 102 extends between the tops of opposing sidewalls 56 and 58, the front wall 60 and the rear wall 62. The cover 102 may be water resistant or water proof. It will be appreciated that the cover 102 may be stretched taut over the cargo compartment 55 and fully covers the cargo compartment 55 without gaps between the cover and the sidewalls. That is, the edges of the cover 102 are secured to the top of the sidewalls 56 and 58, the front wall 60 and the rear wall 62 to form a water resistant or water proof seal in a manner that will be explained in detail hereinafter.

Referring now to FIG. 2, where like reference numerals depict like components, the cover 102 is formed of a stretchable material such that when cargo is placed into the cargo compartment 55, the cover 102 stretches over the cargo and above a top of the sidewalls. It will be appreciated that the cover 102 holds the cargo in place due to its elastomeric nature. That is, as the cover 102 attempts to retract to is normal substantially flat position as shown in FIG. 1, the cover 102 itself exerts a compressive force on the cargo to hold it in place. It will be appreciated that the cover 102 fully covers the cargo compartment 55 without gaps between the cover 102 and the sidewalls.

As shown in FIG. 1, the cover 102 remains substantially flat with an empty vehicle cargo bed. Thus, it will be appreciated that the tonneau cover 102 is operable between a stretched position as shown in FIG. 2 and an unstretched or flat position as shown in FIG. 1. In an embodiment of the present disclosure, the cover 102 is characterized by an absence of straps, buckles, webbing and folds.

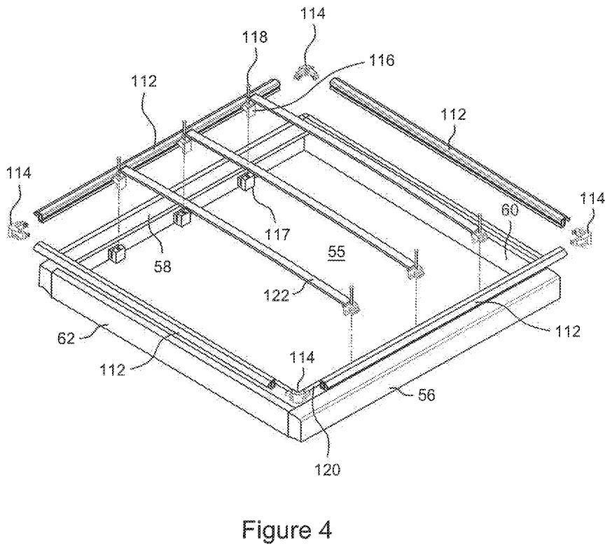

Referring now to FIGS. 3 and 4, where like reference numerals depict like components, in addition to the cover 102, the tonneau cover system 100 may include a friction fit seal 110, elongated rail members 112, rail frame corners 114, upper clamps 116, lower clamps 117, threaded fasteners 118, a gasket 120, and one or more support bows 122.

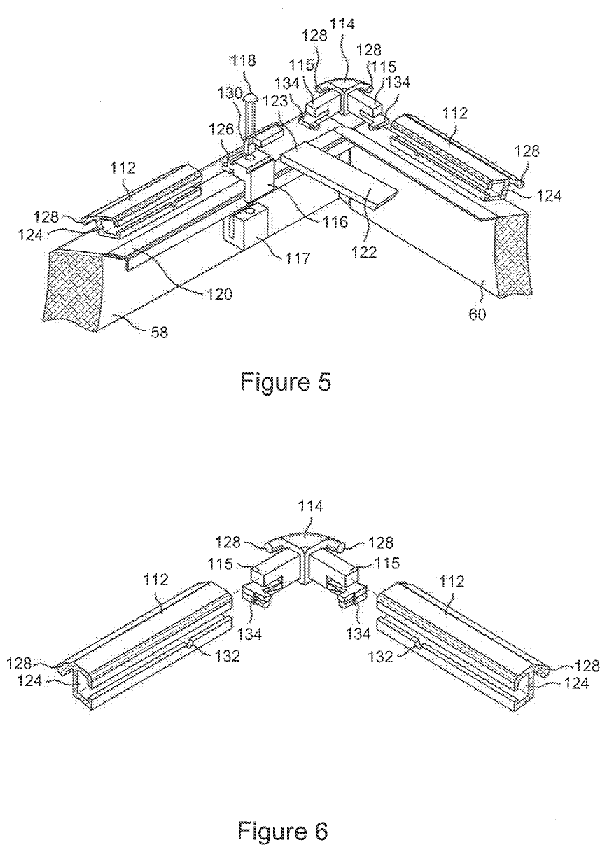

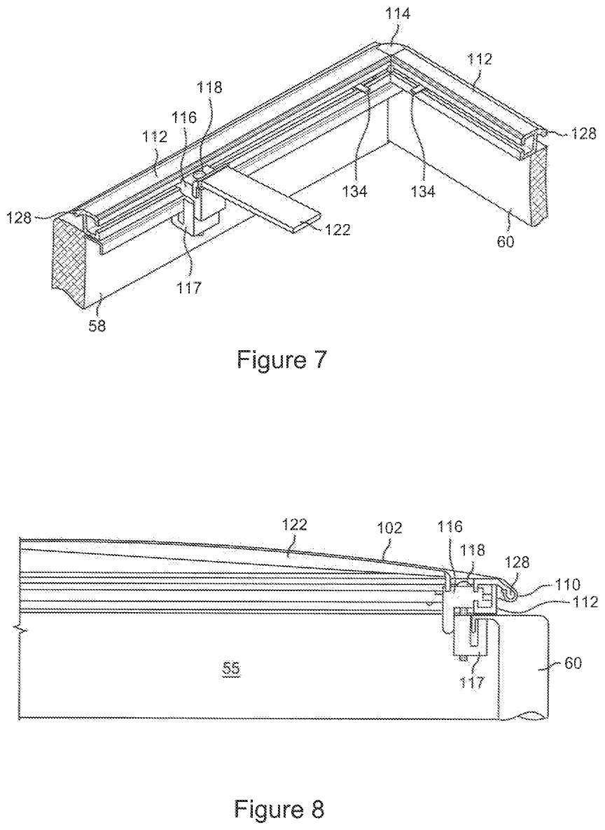

Referring now to FIGS. 5, 6, and 7, where like reference numerals depict like components, the elongated rail members 112 are joined using the rail frame corners 114 to form a rail frame assembly. In an embodiment, the rail frame assembly is rectangular. The rail frame corners 114 comprise insert portions 115 that are configured and adapted to be received into channels formed in the ends of the elongated rail members 112. The rail frame corners 114 lock two adjacent elongated rail members 112 at a right angle using cantilevered and flexible lift locks 134 that engage notches 132 in the elongated rail members 112. The elongated rail members 112 and the rail frame corners 114 each include a cantilevered male projection 128 that extends outwardly. Moreover, when assembled, the elongated rail members 112 and the rail frame corners 114 form a rectangular frame assembly, where the cantilevered male projection 128 extends around the entirety of the rectangular frame. As will be described in more detail hereinafter, the cantilevered male projection 128 provides an attachment point for the cover 102 to the frame assembly.

The elongated rail members 112 (the frame assembly) are joined to the top of the sidewalls (56, 58 and 60) of the truck bed 54 using clamp assemblies, each clamp assembly comprising an upper clamp 116, a lower clamp 117, and a fastener 118. The clamp assemblies clamp the elongated rail members 112 to a cantilevered portion of the sidewalls (56, 58, and 60). The support bows 122 are attached to the upper clamps 116 using an insert member 130 (FIG. 5). It will be appreciated that the bows 122 provide support for the cover 102 when the cover 102 is positioned in a retracted position as shown in FIG. 1. When installed, bows 122 provide an arched structure that allows water, dust and debris to shed off the cover 102 of the tonneau system 100. That is, the bows 122 may impart a slightly rounded shape to the cover 102 as shown in FIG. 1. Thus, as used herein, the term “substantially flat” is understood both flat and slightly rounded shapes.

Referring now to FIG. 8, where like reference numerals depict like components, the edges of the cover 102 of the tonneau cover system 100 are permanently secured to the friction fit seal 110. In an embodiment, the cover 102 and the friction fit seal 110 are permanently secured together using one of an adhesive, stitching, and locking alligator teeth. As observed, the friction fit seal 110 includes a J-hook with an inner female channel configured and adapted to receive and hold the cantilevered male projections 128 of the elongated rail members 112 and the rail frame corners 114. Accordingly, the cover 102 is installed onto the elongated rail members 112 and the rail frame corners 114 by stretching the cover 102 taut and engaging the friction fit seal 110 to the cantilevered male projection 128. It will be appreciated that the friction fit seal 110 and the cantilevered male projection 128 form a seal that is weather, water and debris tight. In this manner, the cover 102 encloses the cargo compartment 55 both in the flat and stretched position as shown in FIGS. 1 and 2. Again, the support bows 122 provide under support for the cover 102 when configured as is shown in FIG. 1.

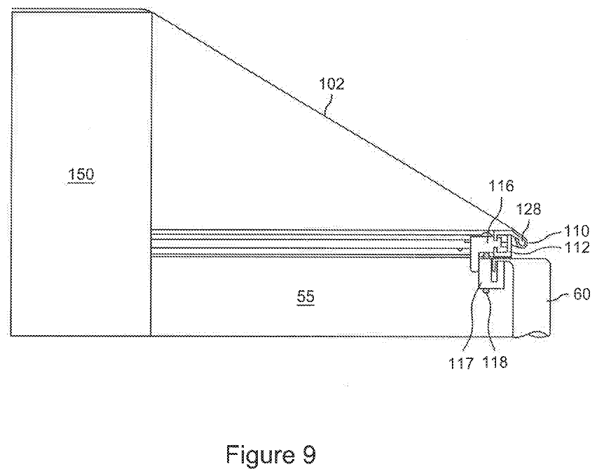

Referring to FIG. 9, where like reference numerals depict like components, there is shown a latitudinal cross section of the tonneau system 100 attached to the truck bed 54. As shown, the cover 102 is configured to a stretched position to accommodate the cargo 150 in the cargo compartment 55. That is, when the cargo 150 is installed in the cargo compartment 55, the cover 102 stretches to accommodate the cargo 150 as is also shown in FIG. 2. In this configuration, the support bows 122 may be removed to accommodate the cargo 150. In an embodiment, the cover 102 may stretch vertically above the tops of the sidewalls by up to, and even exceeding, half the width of the cover 102 as measured from the cover 102 left side and right side. In an embodiment, the cover 102 may stretch vertically above the tops of the sidewalls by up to, and even exceeding, three quarters of the width of the cover 102 as measured from the cover 102 left side and right side. In an embodiment, the cover 102 may stretch vertically above the tops of the sidewalls by up to, and even exceeding, the entire width of the cover 102 as measured from the cover 102 left side and right side. It will be appreciated that the cover 102 may stretch up to 3× its unstretched length.

In an embodiment, the cover 102 is formed of a material having one or more layers, which may include: (a) one or more impervious layers of a stretchable material, e.g., synthetic rubber, closed cell foam, open cell foam, silicone, neoprene, rubber-like, or other material, that is able to stretch in one or more dimensions; and (b) one or more reinforcing layers that is able to stretch in one or more dimensions. The layers of the cover 102 can be in any order. The stretchability and thickness of the cover 102 may vary depending on the layer types and thicknesses. The cover 102 may be formed from one or more sheets of a stretchable material, e.g., synthetic rubber, closed cell foam, open cell foam, silicone, neoprene, rubber-like, or other material. In an embodiment, the cover 102 is formed from sheets of an open cell or closed cell stretchable material.

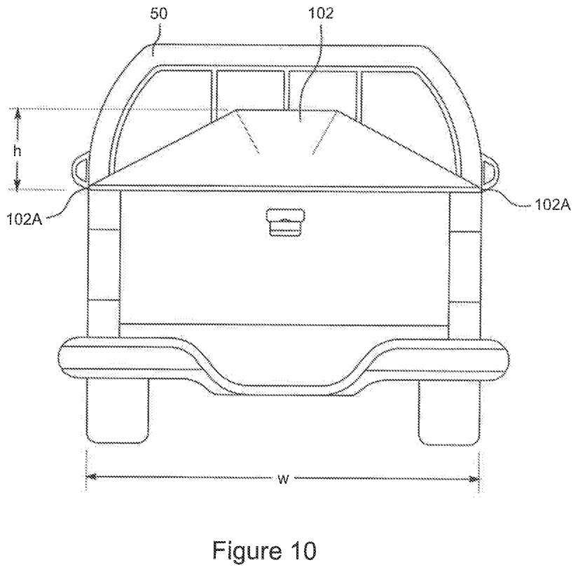

Referring now to FIG. 10, the cover 102 may have a stretch ratio defined as follows:

$$\frac{h}{w}$$

where the w is the width of the cover 102 measured from a left-side or first edge (driver side) 102A of the cover 102 and to a right-side or second edge (passenger side) 102B of the cover 102 and where h is the vertical stretched height of the cover 102 measured vertically from the cover 102 positioned an unstretched or flat position (see FIG. 1). That is, the height, h, is a measurement of the displacement of the cover 102 from a flat position to a stretched position. A value of the stretch ratio is at least 0.1, at least 0.2, at least 0.3, at least 0.4, at least 0.5, at least 0.6, at least 0.7, at least 0.75, at least 0.8, at least 0.9, or at least 1.0. In an embodiment, the width, w, of the cover 102 is at least one foot (0.3 meters), two feet (0.6 meters), three feet (0.91 meters), four feet (1.2 meters), at least five feet (1.52 meters), at least six feet (1.82 meters), at least seven feet (2.13 meters), or at least eight feet (2.44 meters). In an embodiment, the width, w, may be the length of the cover 102 measured from the front edge to the back edge of the cover 102. The width, w, may be a distance between two opposing side edges of the cover 102, such as the distance between the left and right sides of the cover 102 or the distance between the front and rear edges of the cover 102.

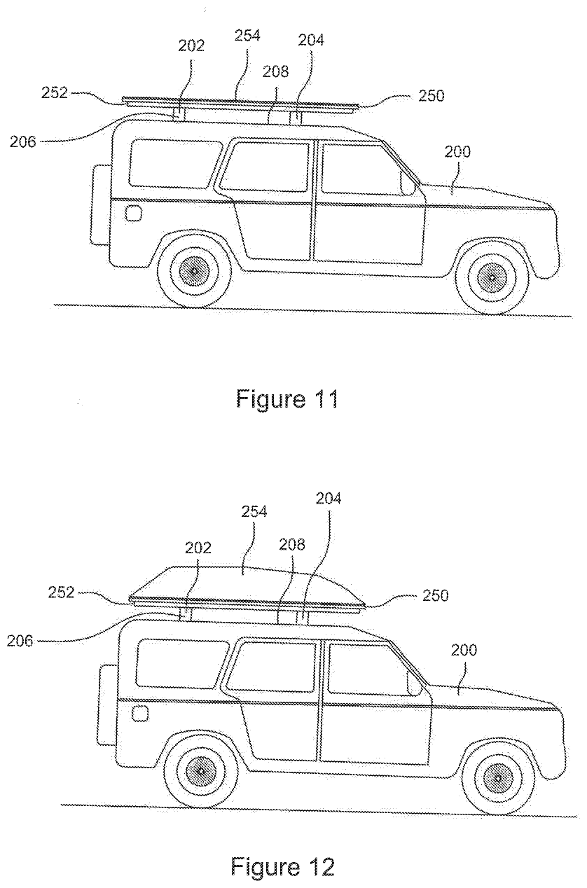

Referring to FIG. 11, there is shown a vehicle 200 having a roof rack 202 with a front rack 204 and a rear rack 206 secured to a roof 208 of the vehicle 200. Mounted on the roof rack 202 is a cargo carrier 250. The cargo carrier 250 may include a base or a frame assembly 252. The assembly 252 may be integral with a solid base so that does not contact the roof of the vehicle 200. For example, the solid base may comprise a tub formed of molded plastic, wood or a composite material. The assembly 252 may be clamped to the front rack 204 and the rear rack 206 with clamps. The assembly 252 may be rectangular, circular, oval, or dished and be formed by elongated rail members and rail frame corners similar in configuration to the elongated rail members 112 and rail frame corners 114 as shown in the preceding figures.

Secured to its edges, the cover 254 may have a friction fit seal similar to the friction fit seal 110 described above. A stretchable cover 254 may be installed onto the assembly 252 in a similar manner as described above such that when cargo is absent from the cargo compartment of the cargo carrier 250, the cover 254 may lay substantially flat as shown in FIG. 11.

As shown in FIG. 12, cargo may be loaded into the cargo compartment of the cargo carrier 250. The cover 254 may be stretched over the cargo and attached to the frame assembly 252 in a similar manner as the tonneau cover 102 is attached to the elongated rail members 112 and rail frame corners 114 as shown in the preceding figures. The cover 254 may have the same composition and stretchability of the tonneau cover 102 as described above.

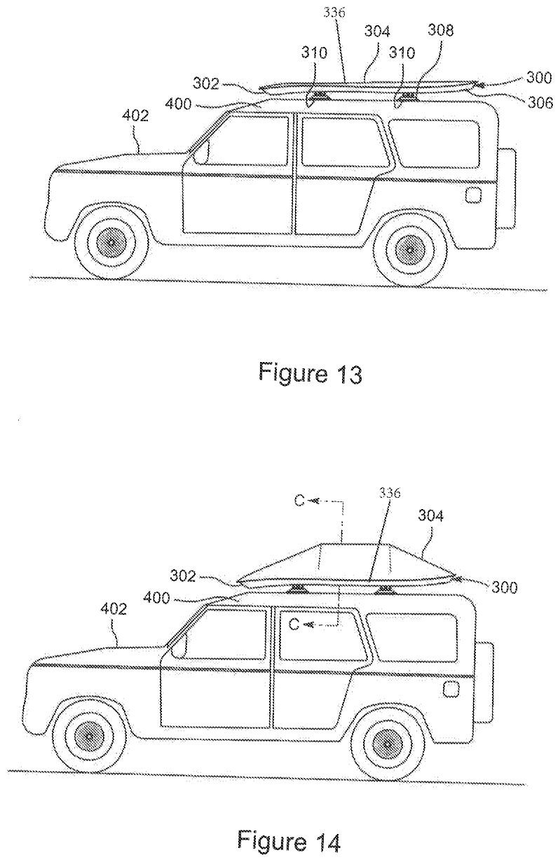

Referring now to FIG. 13, there is shown a cargo carrier 300 mounted to a top 400 of a vehicle 402. The cargo carrier 300 may include a base portion 302 and a cover 304. Extending from an underside 306 of the base portion 302 are mounting assemblies 308. The mounting assemblies 308 may each include a suction cup 310 for mounting the cargo carrier 300 to the top 400 of the vehicle 402 using a suction force. The cargo carrier 300 may include multiple mounting assemblies 308, including two, three, four, or more. Alternatively, the mounting assemblies 308 may comprise brackets and bolts for securing the cargo carrier 300 to a roof rack of a vehicle. Alternatively, the mounting assemblies 308 may comprise clamps for securing the cargo carrier 300 to a roof rack of a vehicle.

The cover 304 may be formed from one or more contiguous sheets of an elastic or stretchable material, e.g., synthetic rubber, closed cell foam, open cell foam, silicone, neoprene, rubber-like, or other material. In an embodiment, the cover 304 is formed from sheets of an open cell or closed cell stretchable material. The cover 304 may be secured along a top edge of the base portion 302. The cover 304 may be removed from the base portion 302 to place a load in the cargo carrier 300. When there is no load, the cover 304 is substantially flat due to its elastic nature. It will be appreciated that a space between the base portion 302 and the cover 304 forms an expandable cargo compartment 320. In an embodiment, the cover 304 is characterized by an absence of folds.

Referring to FIG. 14, the cargo carrier 300 is shown with a load placed in the cargo compartment 320. The cover 304 stretches over the load and is secured to the base portion 302. The resilient nature of the cover 304 keeps the load secured within the cargo compartment. The cover 304 forms a weatherproof barrier that prevents water and debris from entering into the cargo compartment.

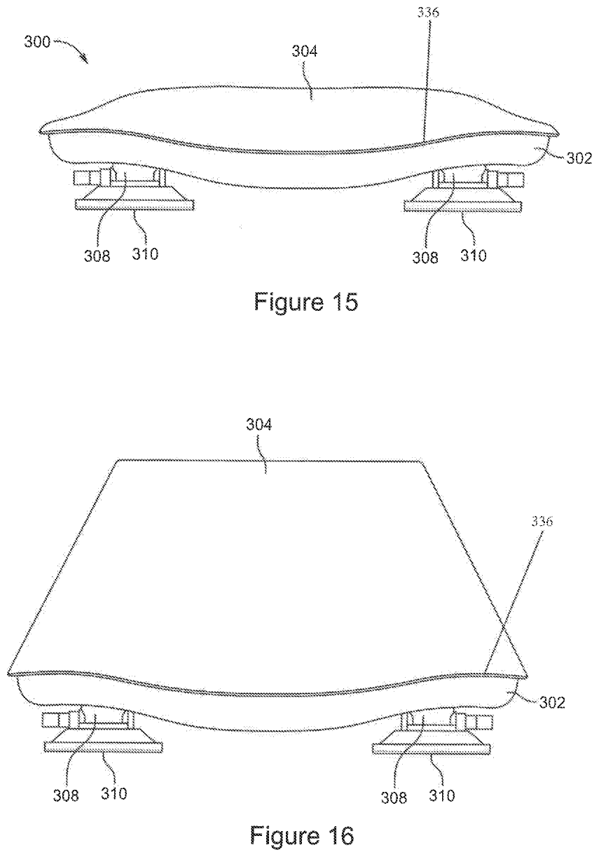

Referring to FIG. 15, there is shown a front view of the cargo carrier 300 without a load. As can be observed, the cover 304 lays substantially flat and is secured along the entirety of a top edge of the base portion 302. As shown in FIG. 16, when a load is placed in the cargo compartment, the cover 304 stretches to accommodate the load. It will be appreciated that the load may be any type of cargo, including personal items, boxes, and the like.

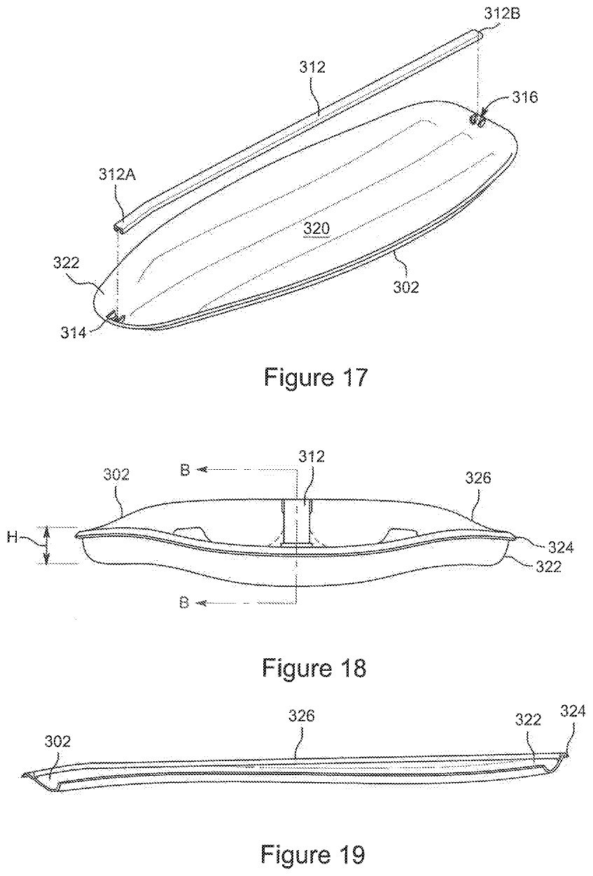

Referring to FIG. 17, where like reference numerals depict like components, there is depicted a top, exploded view of the base portion 302. In an embodiment, the base portion 302 may be formed of molded material such as plastic. Alternatively, the base portion may be formed of wood, stamped metal, or a composite material. A top surface of the base portion 302 may have a concave portion to form the cargo compartment 320. Surrounding the cargo compartment 320 may be a sidewall 322. A support bow 312 may extend from a front portion of the base portion 302 to a rear portion of the base portion 302. Alternatively, the support bow 312 may extend laterally. In addition, more than one support bow may be utilized. The support bow 312 is removable to accommodate cargo.

A front end 312A of the support bow 312 may be installed into a front mount 314 and a rear end 312B of the support bow 312 be installed into a rear mount 316. It will be appreciated that the support bow 312 provides support for the cover 304 when there is no load or small loads in the base portion 302. The support bow 312 is removable by a user when needed. In an embodiment, the base portion 302 is substantially flat with no sidewalls.

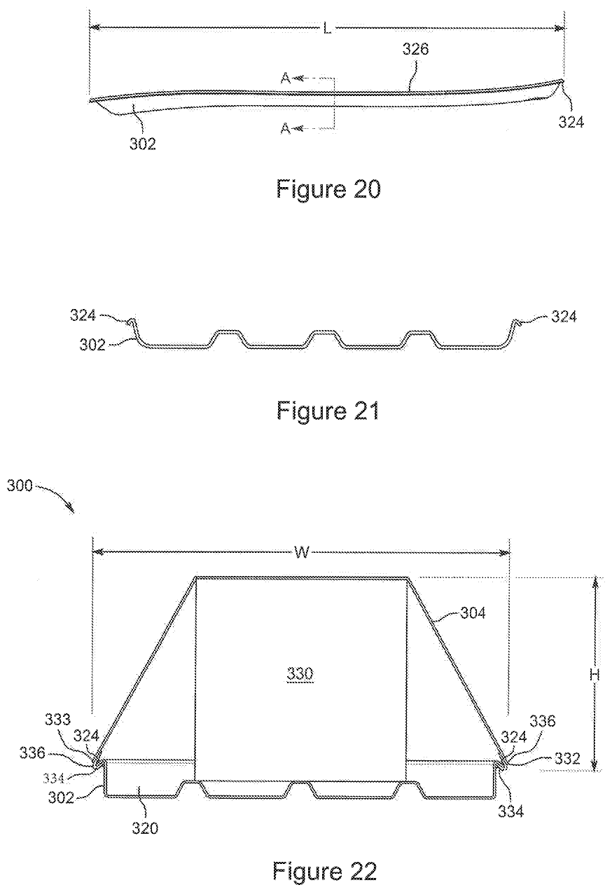

Referring to FIG. 18, a height, H, of the sidewalls 322 may be between about 0 centimeters to about 80 centimeters. Referring to FIGS. 18 and 19, a cantilevered male projection 324 may extend outwardly from a top edge 326 of the base portion 302. The cantilevered male projection 324 may extend around the entirety of the base portion 302. It will be appreciated that the cantilevered male projection 324 provides an anchor to secure the cover 304 as will be explained below. Referring to FIG. 20, where like reference numerals depict like components, a length, L, of the base portion 302 may be between 0.2 meters to about 4 meters. Referring to FIG. 21, where like reference numerals depict like components, there is shown a lateral section of the base portion 302 taken along the section A-A shown in FIG. 20.

Referring to FIG. 22, there is shown a cross-sectional view of the cargo carrier 300 taken along the section C-C shown in FIG. 14. A load 330 is disposed within the cargo compartment 320 of the base portion 302. The cover 304 is installed over the load 330. A first side edge 332 of the cover 304 is secured to the cantilevered male projection 324 using a J-hook 334 to form a friction fit seal 336. A second side edge 333 of the cover 304 is secured to the cantilevered male projection 324 using a J-hook 334 to form a friction fit seal 336.

In particular, the friction fit seal 336 is formed between an inner female channel of the J-hook 334 that is configured and adapted to receive and hold the cantilevered male projection 324 of the base portion 302. It will be appreciated that the friction fit seal 336 extends around the entirety of the top edge 326 of the base portion 302 as shown in FIGS. 13, 14, 15, 16, and 22. That is, the cantilevered male projection 324 and the J-hook 334 extend around the entirety of the base portion 302 and the cover 304, respectively. Reinforcing members may be disposed in an inner portion of the J-hook 334. In an embodiment, the J-hook 334 may be formed of a flexible material, such as plastic or PVC. In an embodiment, the reinforcing members disposed within the J-hook 334 may be formed of a metal, such as aluminum. Alternatively, the cover 304 may be attached to the base portion 302 using other means, including zippers, hook and loop, snaps, catches, cords, straps, and the like.

In an embodiment, the cover 304 is formed of a single or composite elastic material having one or more layers, which may include: (a) one or more impervious layers of a rubber-like material, e.g., synthetic rubber, closed cell foam, open cell foam, silicone, neoprene, or other material, that is able to stretch in one or more dimensions; and (b) one or more reinforcing layers that is able to stretch in one or more dimensions. The layers of the cover 304 can be in any order. The stretchability and thickness of the cover 304 may vary depending on the layer types and thicknesses. The cover 304 may be formed from one or more sheets of a rubber-like material, e.g., synthetic rubber, closed cell foam, open cell foam, silicone, neoprene, or other material. In an embodiment, the cover 304 is formed from sheets of an open cell or closed cell stretchable material. The cover 304 may be able to stretch more than 3× its unstretched length.

Referring still to FIG. 22, the cover 304 may have a stretch ratio defined as follows:

$$\frac{h}{w}$$

where the w is the width of the cover 304 measured from a left-side or first edge 332 of the cover 304 to a right-side or second edge 333 of the cover 304 and where h is the vertical stretched height of the cover 304 measured vertically from the cover 304 positioned an unstretched or flat position (see FIG. 13). That is, the height, h, is a measurement of the displacement of the cover 304 from a flat position to a stretched position. A value of the stretch ratio is at least 0.1, at least 0.2, at least 0.3, at least 0.4, at least 0.5, at least 0.6, at least 0.7, at least 0.75, at least 0.8, at least 0.9, or at least 1.0. In an embodiment, the width, w, of the cover 304 is at least one foot (0.3 meters), two feet (0.61 meters), three feet (0.91 meters), four feet (1.2 meters), five feet (1.52 meters), or even up to seven meters. The width, w, may be a distance between two opposing side edges of the cover 304, such as the distance between the left and right sides of the cover 304 or the distance between the front and rear edges of the cover 304. In an embodiment, the height, h, may be at least one foot (0.3 meters), two feet (0.61 meters), three feet (0.91 meters), four feet (1.2 meters), or five feet (1.52 meters).

### EXAMPLES

The following examples pertain to further embodiments.

Example 1 is a tonneau system for a cargo compartment of a vehicle that comprises a tonneau frame assembly; a tonneau cover connected to the tonneau frame assembly; and where the tonneau cover comprises an elastic material, such as a synthetic rubber or rubber-like material.

In Example 2, the system of Example 1 further comprises that the tonneau cover comprises a first side edge and a second side edge; where the first side edge and the second side edge are on opposite sides of the cover and, optionally, are parallel; wherein a distance between the first side edge and the second side edge defines a tonneau cover width, w; where the width, w, is at least four feet (1.2 meters); where the tonneau cover is operable between a flat position and a stretched position; where a displacement of the tonneau cover between the flat position and the stretched position defines a tonneau cover stretch height, h; where a stretch ratio is defined by

$$\frac{h}{w}$$

is at least 0.1.

In Example 3, the system of Example 2, where the ratio is at least 0.2.

In Example 4, the system of Example 2, where the ratio is at least 0.3.

In Example 5, the system of Example 2, where the ratio is at least 0.4.

In Example 6, the system of Example 2, where the ratio is at least 0.5.

In Example 7, the system of Example 2, where the ratio is at least 0.6.

In Example 8, the system of Example 2, where the ratio is at least 0.7.

In Example 9, the system of Example 2, where the ratio is at least 0.75.

In Example 10, the system of Example 2, where the ratio is at least 0.8.

In Example 11, the system of Example 2, where the ratio is at least 0.9.

In Example 12, the system of Example 2, where the ratio is at least 1.0.

In Example 13, the system of any of Examples 1-12, where the elastic material is an elastomeric material.

In Example 14, the system of any of Examples 1-13, where the tonneau cover is characterized by an absence of expandable folds.

In Example 15, the system of any of Examples 1-14, where the elastic material comprises one or more of neoprene, cell foam, open cell foam, closed cell foam, or other waterproof stretchable material.

In Example 16, the system of any of Examples 1-15, where the elastic material comprises a first layer and a second layer, where the first layer is formed of a synthetic rubber material and the second layer is formed of a reinforcement material.

Example 17 is a tonneau system for a cargo compartment of a vehicle that comprises a tonneau frame assembly comprising a plurality of elongated rail members arranged in a rectangular shape; a cantilevered male projection extending around a perimeter of the rectangular shape of the tonneau frame assembly; a tonneau cover having a friction fit seal disposed along an outside perimeter; the friction fit seal having a channel for receiving the cantilevered male projection; wherein the tonneau cover comprises an elastic material; wherein the tonneau cover comprises a first side edge and a second side edge; where the first side edge and the second side edge are on opposite sides of the cover; wherein a distance between the first side edge and the second side edge defines a tonneau cover width, w; wherein the width, w, is at least four feet (1.2 meters); wherein the tonneau cover is operable between a flat position and a stretched position; wherein a displacement of the tonneau cover between the flat position and the stretched position defines a tonneau cover stretch height, h; wherein a stretch ratio is defined by

$$\frac{h}{w}$$

is at least 0.1.

In Example 18, the system of Example 17, where the ratio is at least 0.2.

In Example 19, the system of Example 17, where the ratio is at least 0.4.

In Example 20, the system of Example 17, where the ratio is at least 0.5.

In Example 21, the system of Example 17, where the ratio is at least 0.6.

In Example 22, the system of Example 17, where the ratio is at least 0.7, 0.75, 0.8, 0.9, or 0.10.

In Example 23, it is a method of securing cargo in a bed of a pick-up truck, the bed having a front sidewall, a right sidewall, a left sidewall, and a rear sidewall, the method comprising: removing, at least partially, a tonneau cover from a frame assembly installed onto a top surface of each of the front sidewall, right sidewall and left sidewall by disconnecting the tonneau cover from the frame assembly; placing cargo in the bed; and reinstalling the tonneau cover onto the frame assembly by stretching the tonneau cover over the cargo and reattaching the tonneau cover to the frame assembly.

In Example 24, the method of Example 23, wherein the tonneau cover comprises a first side edge and a second side edge; wherein the first side edge and the second side edge are on opposing sides of the cover, wherein a distance between the first side edge and the second side edge defines a tonneau cover width, w; wherein the width, w, is at least four feet (1.2 meters); wherein the tonneau cover is operable between a flat position and a stretched position when installed onto the frame assembly; wherein a displacement of the tonneau cover between the flat position and the stretched position defines a tonneau cover stretch height, h; wherein a stretch ratio is defined by

$$\frac{h}{w}$$

is at least 0.1.

In Example 25, the method of Example 24, wherein the stretch ratio is at least 0.25.

In Example 26, a system for securing cargo in an open top cargo compartment, the system comprising: a frame assembly; a cover connected to the frame assembly; and wherein the cover comprises a sheet of an elastic material.

In Example 27, a cargo carrier for a top of a vehicle characterized by: a base portion defining a cargo compartment; a cover disposed over the cargo compartment of the base portion; means for attaching the cover to the base portion; and the cover is formed of an elastic material.

In Example 28, Example 27 is further characterized in that: the cover comprises a first side edge and a second side edge; the first side edge and the second side edge are disposed on opposing sides of the cover; a distance between the first side edge and the second side edge defines a cover width, w; the cover is operable between a flat position and a stretched position; a vertical displacement of the cover between the flat position and the stretched position defines a cover stretch height, h; wherein a stretch ratio for the cover defined by

$$\frac{h}{w}$$

is at least 0.1.

In Example 29, Example 27 is further characterized in that: the stretch ratio is one of at least 0.2, at least 0.3, at least 0.4, at least 0.5, at least 0.6, at least 0.7, least 0.8, at least 0.9, at least 1.0.

In Example 30, any of the preceding Examples further characterized in that the cover is characterized by an absence of expandable folds.

In Example 31, any of the preceding Examples further characterized in that the cover comprises one of neoprene, open cell foam, closed cell foam, rubber, and silicone.

In Example 32, any of the Examples 27-31 is further characterized in that a top edge of a sidewall of the base portion has a male cantilevered projection.

In Example 33, Example 32 is further characterized in that an edge of the cover has a J-hook for engaging the male cantilevered portion.

In Example 34, any of the Examples 27-33 is further characterized in that a plurality of mounting assemblies for securing the base portion to the top of the vehicle.

In Example 35, Example 34 further characterized by each of the mounting assemblies (308) comprises a suction cup (310).

It will be appreciated that the present invention can be utilized on a wide variety of vehicles, including pickup trucks, trailers, military vehicles, or any other type of vehicle with an exposed cargo space. As used herein, the term “elastomeric material” refers to a material that comprises an elastomer, e.g., an elastic substance occurring naturally, as natural rubber, or produced synthetically, as butyl rubber, neoprene, cell foam, closed cell, open cell phone, or other stretchable, water proof material.

It will be appreciated that the structure and apparatus disclosed herein is merely one example of a means for expanding a tonneau cover, and it should be appreciated that any structure, apparatus or system for expanding a tonneau cover which performs functions the same as, or equivalent to, those disclosed herein are intended to fall within the scope of a means for expanding a tonneau cover, including those structures, apparatus or systems for expanding a tonneau cover which are presently known, or which may become available in the future. Anything which functions the same as, or equivalently to, a means for expanding a tonneau cover falls within the scope of this element.

Those having ordinary skill in the relevant art will appreciate the advantages provide by the features of the present disclosure. For example, it is a feature of the present disclosure to provide a tonneau cover that is operable between a collapsed position and an expanded position that is characterized by the absence of folds. It is further a feature to provide a tonneau cover with self-retracting means.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A cargo carrier for a top of a vehicle comprising:
a base portion defining a cargo compartment;
a cover disposed over the cargo compartment of the base portion;
the cover attached to the base portion; and
the cover is formed of an elastic material.

2. The cargo carrier of claim 1, wherein:
the cover comprises a first side edge and a second side edge;
the first side edge and the second side edge are disposed on opposing sides of the cover;
a distance between the first side edge and the second side edge defines a cover width, w, when attached to the base portion;
the cover is operable between a flat position and a stretched position;
a vertical displacement of the cover between the flat position and the stretched position defines a cover stretch height, h;
wherein a stretch ratio for the cover defined by
$$\frac{h}{w}$$
is at least 0.3.

3. The cargo carrier of claim 2, characterized in that the stretch ratio is at least 0.4.

4. The cargo carrier of claim 2, characterized in that the stretch ratio is at least 0.5.

5. The cargo carrier of claim 2, characterized in that the stretch ratio is at least 0.6.

6. The cargo carrier of claim 2, characterized in that the stretch ratio is at least 0.7.

7. The cargo carrier of claim 2, characterized in that the stretch ratio is at least 0.8.

8. The cargo carrier of claim 2, characterized in that the stretch ratio is at least 0.9.

9. The cargo carrier of claim 1, wherein the cover is characterized by an absence of expandable folds.

10. The cargo carrier of claim 1, characterized in that the cover comprises one of neoprene, open cell foam, closed cell foam, rubber, and silicone.

11. The cargo carrier of claim 1, characterized in that the base portion has a male cantilevered projection.

12. The cargo carrier of claim 11, wherein an edge of the cover has a J-hook for engaging the male cantilevered projection.

13. The cargo carrier of claim 1, further comprising a plurality of mounting assemblies for securing the base portion to the top of the vehicle.

14. The cargo carrier according to claim 13, characterized in that each of the mounting assemblies comprises a suction cup.
